(19) United States
(12) Patent Application Publication
(10) Pub. No.: US 2013/0135083 A1
(43) Pub. Date: May 30, 2013

(54) ARTICLE-TRACKING SYSTEM AND METHOD USING RFID TAGS

(71) Applicants: HSIN-PEI CHANG, Tu-Cheng (TW); ZONG-YUAN SUN, Tu-Cheng (TW); DA-HUA XIAO, Shenzhen City (CN)

(72) Inventors: HSIN-PEI CHANG, Tu-Cheng (TW); ZONG-YUAN SUN, Tu-Cheng (TW); DA-HUA XIAO, Shenzhen City (CN)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 13/596,030

(22) Filed: Aug. 27, 2012

(30) Foreign Application Priority Data
Nov. 28, 2011 (CN) 201110383683.X

(51) Int. Cl. G06K 7/01

(52) U.S. Cl. 340/10.1

(57) ABSTRACT

A control unit for tracking articles is positioned approximate to a package and communicates with a reader. The control unit includes a radio frequency identification (RFID) tag, a switch, a clock; and a microcontroller. The switch outputs a first control signal to the microcontroller when the package is opened. The microcontroller reads a real-time clock (RTC) signal from the clock according to the first control signal, and transmits an open status signal and the corresponding RTC signal to the RFID tag. The RFID tag feeds back the open status signal and the corresponding RTC signal to an RFID reader.

### CROSS-REFERENCE TO RELATED APPLICATIONS

This application is one of the three related co-pending U.S. patent applications listed below. All listed applications have the same assignee. The disclosure of each of the listed applications is incorporated by reference into each of the other listed applications.

| Attorney | | |
|---|---|---|
| Docket No. | Title | Inventors |
| US 42979 | ARTICLE-TRACKING SYSTEM AND | HSIN-PEI |
| | METHOD USING RFID TAGS | CHANG et al. |
| US 43084 | ARTICLE-TRACKING SYSTEM AND | HSIN-PEI |
| | METHOD USING RFID TAGS | CHANG et al. |
| US 43160 | ANTI-THEFT SYSTEM USING RFID | HSIN-PEI |
| | TAGS | CHANG et al. |

### BACKGROUND

1. Technical field

The disclosure generally relates to article-tracking systems, and particularly relates to a system to track articles using radio frequency identification (RFID) tags and a method thereof.

2. Description of the Related Art

Tracking and verifying of articles has evolved in transportation business through the use of RFID tags. RFID tags can be attached to articles and be packed in a package (e.g., a box). However, the articles may be stolen or replaced by fakes during the transportation process if one opens the package before deliverance of the package, and this will cause economic losses for manufacturers and sellers.

Therefore, there is room for improvement within the art.

### BRIEF DESCRIPTION OF THE DRAWINGS

Many aspects of an exemplary article-tracking system and method using RFID tags can be better understood with reference to the drawings. The components in the drawings are not necessarily drawn to scale, the emphasis instead being placed upon clearly illustrating the principles of the disclosure.

FIG. 1 is a schematic view of an article-tracking system using RFID tags, according to an exemplary embodiment.

FIG. 2 is a block diagram of a control unit of the article-tracking system using RFID tags as shown in FIG. 1.

### DETAILED DESCRIPTION

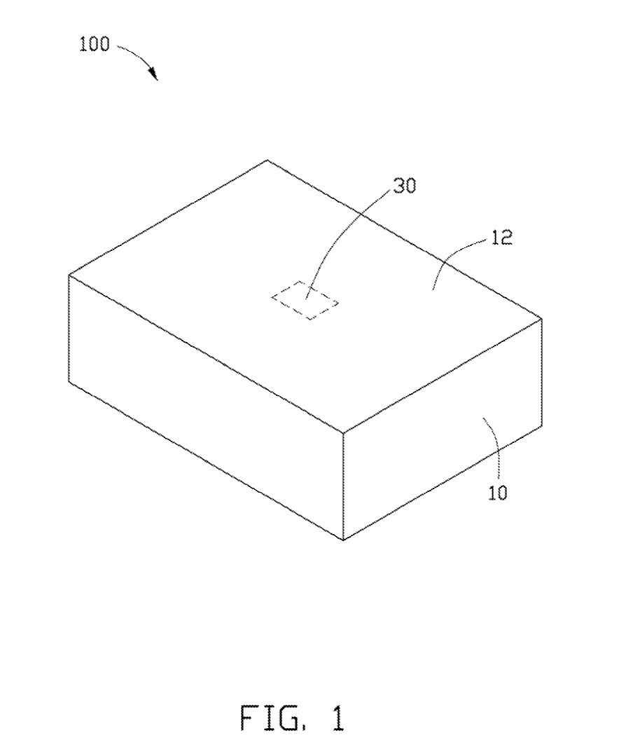

FIG. 1 is a schematic view of an article-tracking system 100 using RFID tags, according to an exemplary embodiment. The article-tracking system 100 can track articles using RFID tags during packing, transportation, and verification processes of the articles. The article-tracking system 100 includes a package 10 and a control unit 30. The articles can be luxurious cigarettes, clothes, computers, or confidential files, for example.

The package 10 can be a box or any suitable storage container to accommodate the articles. The package 10 includes a cover 12 (e.g., a lid or the top of a box) where the articles are packed in the package 10, and then the cover 12 can be sealed.

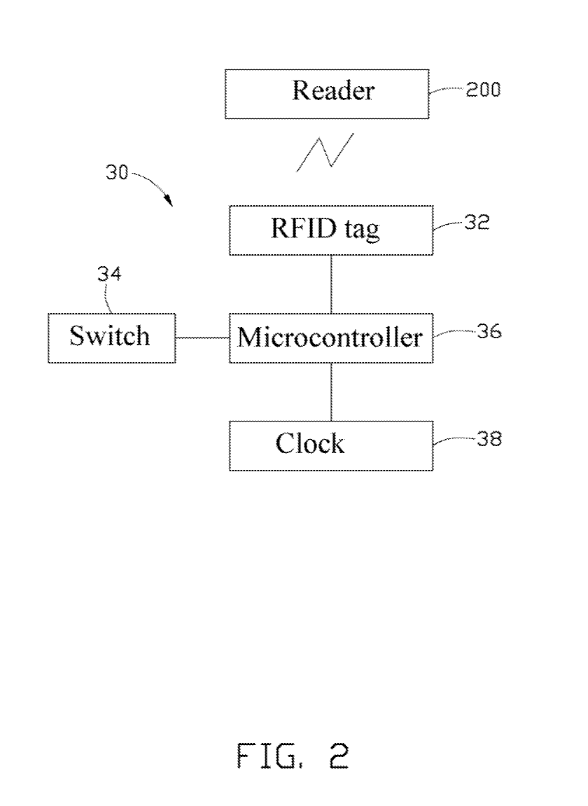

Referring to FIG. 2, the control unit 30 can be positioned on the cover 12 or any position approximate to a surface of the package 10, and includes a RFID tag 32, a switch 34, a microcontroller 36, and a clock 38. The RFID tag 32, the switch 34, and the clock 38 are all electronically connected to the microcontroller 36.

The RFID tag 32 communicates with a reader 200 via radio frequency (RF) signals, for receiving clock signals from the reader 200 and feeding back tracking data to the reader 200. The tracking data may include open/closed status signals and corresponding real-time clock (RTC) signals, the open/closed status signals may be digital signals such as logic “1” or logic “0”, and can represent that the cover 12 is in an open/closed status. In one exemplary embodiment, the operating frequency of the RFID tag 32 can be 125 KHz, 13.56 MHz, 433 MHz, 900 MHz, 2.45 GHz, or 5.8 GHz.

The switch 34 may be a mechanical switch or an electrical switch. The switch 34 is configured for outputting a first control signal and a second control signal in response to the open status and the closed status respectively of the cover 12. If the cover 12 is open, the switch 34 outputs the first control signal (e.g., logic 0). If the cover 12 is closed, the switch 34 outputs the second control signal (e.g., logic 1).

The microcontroller 36 obtains the clock signals from the RFID tag 32, and sets or resets the clock 38 accordingly. The microcontroller 36 receives the first control signal or the second control signal output from the switch 34, and then reads the RTC signal from the clock 38. In one embodiment, the microcontroller 36 may be an initial sleep state before receiving the first control signal or the second control signal output from the switch 34 in order to conserve power. Upon receiving the first control signal or the second control signal, the microcontroller 36 goes to an on state from the sleep state.

Additionally, the microcontroller 36 predetermines a threshold period of time (e.g., 100 ms). The microcontroller 36 determines whether a time difference between receiving the first control signal and the second control signal is less than the threshold time period, and then transmits the open/closed status signals and the corresponding RTC signal to the RFID tag 32 according to the determination. If the time difference between receiving the first control signal and the second control signal is more than the threshold time period, the microcontroller 36 will transmit the open/closed status signals and the corresponding RTC signal to the RFID tag 32. In this condition, the package 10 may be opened or/and closed by manual manipulation of the cover 12. If the time difference between receiving the first control signal and the second control signal is less than or equal to the threshold time period, the microcontroller 36 will not transmit the open/closed status signals and the corresponding RTC signal to the RFID tag 32. In this condition, the package 10 may be opened or/and closed by other actions, such as a mechanical vibration of the cover 12, for example.

An article-tracking method of the aforementioned article-tracking system 100 is described according to an exemplary embodiment. The article-tracking method includes at least following steps:

In step S1, during the packing process, the article(s) are packed in the package 10, and the cover 12 is sealed. Then, the RFID tag 32 communicates with the reader 200 to receive clock signals from the reader 200, and then the RFID tag 32 transmits the clock signals to the microcontroller 36. The microcontroller 36 sets or resets the clock 38 to allow the clock 38 to begin counting. Then, the microcontroller 36 can enter in the sleep state for conserving power. For example, the cover 12 might be closed at 8:50, and the clock 38 would begin to time from 8:50.

In step S2, during the transportation process of the article(s), the switch 34 outputs the first control signal to the microcontroller 36 if the cover 12 is opened, and outputs the second control signal if the cover 12 is closed. For example, the cover 12 may be opened at 15:20, and closed at 15:35. Thus, the switch would output the first control signal at 15:20, and would output the second control signal at 15:35.

In step S3, the microcontroller 36 enters the on state when the microcontroller 36 receives the first control signal, and then reads the RTC signal from the clock 38. The microcontroller 36 further compares the threshold time period and the time difference between receiving the first control signal and the second control signal. In one exemplary embodiment, the time difference between receiving the first control signal and the second control signal is about 15 minutes, and this period is more than the threshold time period (e.g., 100 ms). Thus, the microcontroller 36 transmits the open/closed status signals and the corresponding RTC signal to the RFID tag 32.

In step S4, during the verification process of the article(s), the RFID tag 32 feeds back the tracking data comprising the open/closed status signals and the corresponding RTC signal to the reader 200 via RF communication.

The article-tracking system 100 can detect whether the package 10 is opened and closed, and the switch 34 outputs the first control signals and the second control signals accordingly. Thus, the microcontroller 30 reads the RTC signal from the clock 38, and the open/closed status signals and the corresponding RTC signal can be fed back to the reader 200 via the RFID tag 32. Therefore, the manufacturers and sellers can directly know when and how many times the package 10 is opened, and the tracking of articles is sufficient to efficiently protect the articles from being stolen or replaced by fakes.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A control unit positioned approximate to a package and in electronic communication with a reader, comprising:
a radio frequency identification (RFID) tag;
a switch;
a clock; and
a microcontroller electronically connected to the RFID tag, the switch, and the clock;
wherein the switch outputs a first control signal to the microcontroller when the package is opened, the microcontroller reads a real-time clock (RTC) signal from the clock according to the first control signal, and transmits an open status signal and the corresponding RTC signal to the RFID tag, the RFID tag feeds back the open status signal and the corresponding RTC signal to the reader.

2. The control unit as claimed in claim 1, wherein the RFID tag receives clock signals from the reader via radio frequency (RF) communication.

3. The control unit as claimed in claim 2, wherein the microcontroller obtains the clock signals from the RFID tag, and sets or resets the clock accordingly.

4. The control unit as claimed in claim 1, wherein the switch outputs a second control signal to the microcontroller when the package is closed, the microcontroller reads a RTC signal from the clock according to the second control signal, and transmits a closed status signal and the corresponding RTC signal to the RFID tag.

5. The control unit as claimed in claim 4, wherein the microcontroller predetermines a threshold time period, and the microcontroller determines whether a time difference between receiving the first control signal and the second control signal is less than the threshold time period.

6. The control unit as claimed in claim 5, wherein if the time difference between receiving the first control signal and the second control signal is more than the threshold time period, the microcontroller transmits the open/closed status signals and the corresponding RTC signal to the RFID tag.

7. The control unit as claimed in claim 5, wherein if the time difference between receiving the first control signal and the second control signal is less than or equal to the threshold time period, the microcontroller dose not transmit the open/closed status signals and the corresponding RTC signal to the RFID tag.

8. An article-tracking method, comprising:
(a) outputting a first control signal via a switch positioned approximate to a package when the package is opened;
(b) reading a real-time clock (RTC) signal from a clock by a microcontroller, according to the first control signal;
(c) transmitting the RTC signal to a radio frequency identification (RFID) tag by the microcontroller;
(d) feeding back the RTC signal to a reader via the RFID tag.

9. The article-tracking method as claimed in claim 8, further comprising receiving a clock signal from the reader via the RFID tag, and setting or resetting the clock by the microcontroller according to the clock signal before the step (a).

10. The article-tracking method as claimed in claim 8, further comprising outputting a second control signal via the switch when the package is closed.

11. The article-tracking method as claimed in claim 10, further comprising transmitting open/closed status signals to the RFID tag by the microcontroller.

12. The article-tracking method as claimed in claim 11, further comprising:
determining whether a time difference between receiving the first control signal and the second control signal is less than a predetermined threshold time period, and
transmitting the RTC signal and the open/closed status signals to the RFID tag if the time difference is more than the predetermined threshold time period.
